(19) United States
(12) Patent Application Publication
(10) Pub. No.: US 2016/0109916 A1
(43) Pub. Date: Apr. 21, 2016

(54) METHOD AND APPARATUS FOR SUSTAINABLE SCALE-OUT DATACENTERS

(71) Applicant: University of Florida Research Foundation, Incorporated, Gainesville, FL (US)

(72) Inventors: Tao Li, Gainesville, FL (US); Chao Li, Gainesville, FL (US)

(21) Appl. No.: 14/886,843

(22) Filed: Oct. 19, 2015

Related U.S. Application Data
(60) Provisional application No. 62/065,449, filed on Oct. 17, 2014.

(51) Int. Cl. G06F 1/26; H02J 9/06; G06F 1/32; H02J 3/38

(52) U.S. Cl. CPC G06F 1/263; H02J 3/383; H02J 9/062; G06F 1/3287

(57) ABSTRACT

Embodiments relate to a method and apparatus for providing additional power supply to a datacenter receiving power from a power distribution unit (PDU) that provides utility power. The additional power supply can be provided by a renewable power source, such as one or more solar panels. Embodiments can add additional energy storage capacity with the additional power supply and can add additional server(s) with the additional power supply. Embodiments can incorporate a power control hub that controls the delivery of either AC power received from the PDU, or AC power converted from DC power received from the renewable power source and/or DC power received from additional energy storage devices that provide the additional storage capacity to the additional server(s), to the additional server(s).

### CROSS-REFERENCE TO RELATED APPLICATIONS

This application claims the benefit of U.S. Provisional Application Ser. No. 62/065,449, filed Oct. 17, 2014, which is incorporated herein by reference in its entirety.

The subject invention was made with government support under National Science Foundation Contract No. 1117261. The government may have certain rights to this invention.

### BACKGROUND OF INVENTION

The rapid adoption of cloud computing is deemed a powerful engine for the growth of installed server capacity. To support emerging data-analytic workloads that tend to scale well with large number of compute nodes, modern datacenters are continually adding computing resources (i.e., scaling out) to their existing sites. In turn, global server market size is projected to triple in 2020, accounting for over 1000 TWh of annual energy consumption [1, 2].

Over time, the constant influx of server resources into datacenters will eventually result in the datacenters becoming power-constrained. According to a recent industry survey from the Uptime Institute [3], 30% of the enterprise datacenter managers expected to run out of excess power capacity within 12 months. FIG. 1 shows a graph with respect to several widely adopted solutions to the power capacity problem. While leasing collocated racks and deploying cloud services fit the needs of small server clusters on a budget, leasing collocated racks and deploying cloud services may not meet the needs of large-scale enterprise datacenters and approaches, with respect to which improvement in computing capability and capacity may be needed.

Server consolidation employs mature techniques that can free up power capacity. However, in power-constrained datacenters, even consolidated servers have to limit their performance using either software-based (i.e., virtual CPU allocation) or hardware-based (i.e., dynamic voltage and frequency scaling (DVFS)) control knobs to avoid tripping circuit-breakers and causing costly downtime.

Upgrading power systems is a radical solution that allows one to add more servers and racks, and even onsite containers. However, like building a new datacenter, re-sizing a datacenter's power capacity can be a great undertaking since conventional centralized power provisioning schemes do not scale well. In a typical datacenter, the power delivery path involves multiple power equipment elements across several layers, such as the embodiment shown in FIG. 2. Upgrading power infrastructure often requires a re-design of the entire power delivery path, which is not only costly, but also time-consuming. Worse, utility power feeds are often operating at their capacity, such as in certain urban areas, and access to additional electricity for a datacenter can, therefore, be restricted.

In addition, modern scale-out datacenters are not only power-constrained, but also carbon-constrained. As server power demand increases, the associated carbon footprint expansion poses significant challenges for scale-out datacenters. It has been shown that global greenhouse gas (GHG) emissions could easily exceed 100 million metric tons per year if we keep using utility grid power that is generated from conventional fossil fuel [4]. An emerging solution to the carbon reduction problem is to leverage green energy sources to lower the environmental impact of computing systems. Several companies, including Microsoft, IBM, Google, Apple, and eBay, as part of their long-term energy strategies and corporate environmental goals [5-9], have started to explore renewable energy to power datacenters, and even to have one or more renewable energy sources dedicate their output power capacity to the datacenter. An an example, eBay is experimenting with a small datacenter powered by a 100 kW solar array. Apple's Maiden datacenter in North Carolina draws renewable power from both power generated by dedicated renewable power generation facilities (60%) and power generated by a regional plant (40%).

Unfortunately, it appears that existing green energy integration schemes typically employ centralized power integration architecture, which does not take full advantage of the modularity of typical renewable power supplies. As shown in FIG. 2, one of the advantages of such facility-level integration is that the renewable power supplies can be synchronized to the utility grid so as to reduce or eliminate the negative impact of renewable power variation on datacenter servers. However, the operation of such a grid-connected renewable power system often relies on the availability of utility provided power. Meanwhile, the centralized power integration not only results in single-point of failure, but also makes future capacity expansion expensive.

The scale-out model starts to draw great attention these days as emerging cloud application and data-processing workloads tend to scale well with large numbers of compute nodes. There have been several pioneering works, which introduced processor and system level design methodologies for scale-out systems [27, 28]. At the server cluster-level, Kontorinis et al. [10] proposed distributed UPS systems for more cost-effective power over-subscription. Recently, Wang et al. [29] investigated the power scarcity issue in datacenters and proposed power distribution virtualization techniques for managing power-constrained datacenters. Different from existing designs that emphasis improving server efficiency and density to free up datacenter power capacity, this work looks at approaches that provide additional power capacity incrementally to power-constrained servers to enable them to scale out.

There are three interesting stages of development in the design and management of computing systems that takes advantage of green energy systems. At first, designers mainly focused on hardware and system control techniques, with an emphasis on adapting server power to the time-varying renewable power budget [30, 31]. Following that, the second stage features several more flexible solutions that leverage workload adaptation [32-35]. The main idea is to shift deferrable workloads to a time window in which renewable generation is sufficient (temporal adaptation), or to relocate workloads to a different system where power budget is abundant (spatial adaptation). In the third stage, the gap between power supply management and workload management starts to diminish. For example, recent designs have highlighted approaches that cooperatively tune both energy sources and workloads to achieve an optimal operating point [36, 37].

Existing work on carbon-aware systems can also be roughly classified into three categories, as discussed below.

Focusing on Supply-Load Matching

The dominate design pattern for managing mismatches between server power demand and power supply budget is to enable supply-following (a.k.a. supply-tracking) computing load to eliminate supply-demand mismatches. SolarCore [30] leverages per-core DVFS on multi-core systems to track the peak solar power budget, while optimally assigning the power across different workload. Blink [31] leverages the on/off power cycles of server motherboard for tracking wind power supply. Their goal is to minimize the negative impact of temporary server shutdown on internet applications. Recently, iSwitch [38, 39] proposed handling renewable power budget through dynamic VM live migration between two clusters. The proposed technique emphasizes different supply/load tuning policies for different renewable power scenarios. In addition, Chameleon [40] proposed using an online learning algorithm to dynamically select power supplies and power management policies. However, the proposed technique mainly focuses on server level power control. Similar to iSwitch, [41] also divides datacenter clusters into a brown part (which uses utility power) and a green part (which uses renewable power). While this work uses renewable power with a green part of datacenter clusters, the architecture assumes centralized batteries and integrates renewable power at the cluster level.

In contrast to the supply-following based design, recent work on a load-following based design [37] takes advantage of the self-tuning capabilities of some renewable power supplies to match the changes in datacenter server load. In [37], the datacenter power demand is adjusted for improving load following efficiency.

There has been prior work exploring fine-grained renewable power integration in datacenters. For example, Deng et al. [42] investigate the use of grid-tied inverters for managing renewable power distribution. However, this work focuses on concentrating renewable power on green servers and does not consider the role of distributed batteries and modular renewable power supplies.

Several recent papers have discussed the role of batteries in server clusters [43, 44]. These papers propose using energy storages devices to shave peak server power, manage demand-supply mismatch, and avoid unnecessary load migration.

Prior proposals typically assume that the interface between renewable power source and server system is ready. Although the future smart grid is expected to feature a smart communication gateway for providing connectivity and interactive control between onsite power generator and computing load, currently such an interface is not widely adopted.

Focusing on Resource Planning

Many proposals focus on optimizing cost and energy utilization in green datacenters. For example, Liu et.al [35] model and evaluate dynamic load scheduling scheme in geographically distributed systems for reducing datacenter electricity prices. Zhang et al. [33] discuss cost-aware load balancing that maximizes renewable energy utilization. Deng et al. [34] explore algorithms for optimizing clean energy cost for green Web hosts. Recently, Ren et al. [45] demonstrated that intelligently leveraging renewable energy (self-generation or purchasing) can lower datacenter costs, not just cap carbon footprints.

Investigating Field Deployment

Several studies have demonstrated the feasibility of renewable energy powered datacenters. These designs typically employ energy storage devices, grid-tied power controller, or a combination of both to manage renewable power. For example, HP Labs [46] tests a renewable energy powered micro-cluster called Net-Zero for minimizing the dependence on the traditional utility grid. Their scheduling considers shedding non-critical workload to match the time-varying solar energy output.

GreenSwitch proposed a workload and energy source co-management scheme on a prototype green datacenter called Parasol [36]. In this work, the authors highlight datacenter free cooling, low-power server nodes, renewable power prediction, and net-metering mechanism, to address the problem of solar power supply variability and datacenter power demand fluctuation. While [36] targets a broad category of systems from warehouse-scale clusters to small server containers, its discussion mainly focuses on datacenter-level solar power integration and management. [36] emphasizes the role of model-based software power prediction, and uses workload characteristics to guide energy source switching.

### BRIEF SUMMARY

Embodiments of the invention can enable a power-constrained datacenter to scale out, while lowering the increase in the carbon footprint with increased power usage of the datacenter. Preferred embodiments enable the increase in carbon footprint to be lowered, as compared with systems expanding the use of utility power generated from conventional fossil fuel, as the power usage increases, with high efficiency and low overhead. Faced with the ever-growing computing demand, the skyrocketing server power expenditures, and the looming global environmental crisis, such solutions can be of significant benefit to datacenter operators who wish to have efficient power provisioning and management schemes, in order to survive economically in a sustainable fashion.

A specific embodiment, which can be referred to as Oasis, relates to a method and apparatus to implement a unified power provisioning framework that synergistically integrates two, or all three, of the following: energy source control, power system monitoring, and architectural support for power-aware computing where power-aware computing can involve controlling the amount of power consumed by the computing based on the amount of power available, and allocating such computing in a manner to improve the value of the output of the computing based on one or more metrics. A specific embodiment of Oasis leverages modular renewable power integration and distributed battery architecture to provide flexible power capacity increments. Implementation of specific embodiments can allow power-constrained and/or carbon-constrained systems to stay on track with horizontal scaling and computing capacity expansion.

A specific embodiment incorporating a solar panel at the PDU level is implemented as a research platform for exploring key design tradeoffs in multi-source powered datacenter. A first generation embodiment is a micro server rack (12U) that draws power from onsite solar panels, conventional utility power, and local energy storage devices, where U is defined as “a rack unit,” which is 1.75 inches (4.445 cm) high. The operations of these energy sources are coordinated by a control system. In a specific embodiment, the control system includes a micro-controller based power control hub (PCH). The PCH can be customized to be a rack-mounted, interactive system that allows for easy installation and diagnosis.

A further specific embodiment, which can be referred to as Ozone, relates to a power management scheme for operation of an embodiment incorporating a renewable power source (e.g., a solar panel) at the PDU level in an optimized range of operation, and, in a further specific embodiment, to implement an embodiment incorporating a renewable power source (e.g., a solar panel) at the PDU level in an optimized manner, which can be referred to as Optimized Oasis Operation (O3). Embodiments implementing the Ozone control scheme can transcend the boundaries of traditional primary and secondary power, such that these embodiments can create a smart power source switching mechanism that enables the server system to deliver high performance, while maintaining a desired system efficiency and reliability. Embodiments implementing the Ozone control scheme are able to dynamically distill crucial runtime statistics of different power sources to reduce, or avoid, unbalanced usage of different power sources. Embodiments can identify the most suitable control strategies and adaptively adjust the server speed via dynamic frequency scaling to increase, and/or maximize, the benefits of embodiments incorporating a renewable power source (e.g., a solar panel) at the PDU level.

Embodiments incorporating a renewable power source (e.g., a solar panel) at the PDU level and implementing the Ozone control scheme can provide a research platform that can provide one or more of the following: (1) enable a datacenter power system to be introduced and/or enable an existing datacenter power system to scale-out and facilitate partial green power integration, where a datacenter power system is a power system that employs renewable energy sources, can be at least partially controlled by a control subsystem of the datacenter, and/or is located on site at the datacenter such as a dedicated power system dedicated to the datacenter; (2) link power supply management and server system control, and, preferably, enable real-time power supply driven workload scheduling and/or enable real-time workload demand driven power supply output control; (3) power provisioning architecture (i.e., hybrid power supplies+distributed control domain) that can improve datacenter availability in one or more power failure scenarios; (4) decentralized multi-source power management that can provide a datacenter operator the flexibility of offering different green computing services based on different customer expectations.

A specific embodiment of a datacenter, incorporating a renewable power source (e.g., a solar panel) at the PDU level, a power provisioning architecture that enables server power supply to be scaled-out, so as to facilitate initial capacity planning and on-demand datacenter capacity expansion.

A specific embodiment of a datacenter, incorporating a renewable power source (e.g., a solar panel) at the PDU level provides an interactive communication portal between a hybrid power supply and a server system, so as to enable real power-driven workload control and/or workload-driven energy source management.

An embodiment incorporating a renewable power source (e.g., a solar panel) at the PDU level, and implementing the Ozone control scheme, which can be referred to as Optimized Oasis Operation, can jointly optimize battery service life, battery backup time, and workload performance. Evaluation results show that embodiments incorporating a renewable power source (e.g., a solar panel) at the PDU level are able to further reduce workload execution delay to less than 5%, less than 4%, less than 3%, less than 2%, less than 1.5%, and/or less than 1%, extend battery lifetime by over 30%, over 40%, over 45%, and/or over 50%, and/or increase battery autonomy time by a factor of at least 1.5, 1.6, 1.7, 1.8, and/or 1.9, while still maintaining a satisfactory green energy usage rate.

Embodiments incorporating a renewable power source (e.g., a solar panel) at the PDU level can reduce the cost of large-scale datacenter design, by, for example, enabling a scale-out datacenter to increase the datacenter's power generation capacity and/or workload output capacity by a factor of at least 1.5, 1.6, 1.7, 1.8, 1.9, 1.95, and/or 2, with up to 5%, 10%, 15%, 20%, 21%, 22%, 23%, 24%, and/or 25% less cost overhead, compared to the facility-level one-time renewable energy integration.

### BRIEF DESCRIPTION OF DRAWINGS

FIG. 1 shows a graph showing how organizations are predicted to handle increased capacity demand over the next 12-18 months, from the Uptime Institute 2012 Data Center Industry Survey [3].

FIG. 2 illustrate that a conventional datacenter power architecture is not “scale-out friendly”, such that existing facility-level renewable power integration can be costly and problematic.

FIG. 3 shows an embodiment of a power provisioning architecture, which can leverage the modularity of both energy storage systems, e.g., battery systems, and renewable power systems.

FIG. 4 shows how distributed energy storage devices (e.g., batteries) can be used in an implementation of a server cluster [11].

FIGS. 5A-5B shows an embodiment of a system in accordance with the invention (FIG. 5A) and node architecture (FIG. 5B) of an embodiment of a node in accordance with an embodiment of the invention, Where several key components include: (1) network switch, (2) computing nodes, (3) power control hub, (4) battery chassis, (5) converter and inverter, (6) power switch, (7) PLC, and (8) HMI.

FIG. 6 shows a power management agent and the data communication scheme inside an embodiment of a node in accordance with an embodiment of the invention.

FIGS. 7A-7B show the control flow of power supply switching, where an embodiment in autonomous mode uses two atomic modules to control the system, the SupplySense module (FIG. 7A) and the SupplySwitch module (FIG. 7B).

FIG. 8 shows how an embodiment of a power control hub uses threshold to avoid over charging and/or overdischarging a battery, where the voltage droop is caused by inrush currents.

FIGS. 9A-9B show the execution latency due to server performance scaling with high renewable power variability (FIG. 9A) and low renewable power variability (FIG. 9B), where an embodiment of Ozone can achieve very close to the performance of embodiments implementing Oasis-B, which heavily uses batteries to support high server speed.

FIGS. 10A-10B show the estimated battery lifetime calculated from a battery usage profile with high renewable power variability (FIG. 10A) and low renewable power variability (FIG. 10B), where embodiments implementing the Ozone control scheme typically show much better battery lifetime compared to embodiments implementing the Oasis-B control scheme, such that in some scenarios where renewable power is constantly high, embodiments implementing the Ozone control scheme may result in under-utilization of the battery system.

FIGS. 11A-11B show a battery discharging profile and the renewable power supply and server power demand traces (workload: Nutch page indexing) for an embodiment with high renewable power variability (FIG. 11A) and low renewable power variability (FIG. 11B).

FIGS. 12A-12B show the average battery backup capacity with high renewable power variability (FIG. 12A) and low renewable power variability (FIG. 12B), where embodiments implementing the Ozone control scheme maintain a high backup time due to better battery capacity management capability.

FIGS. 13A-13B show the ratio of green energy usage to overall power consumption with high renewable power variability (FIG. 13A) and low renewable power variability (FIG. 13B), where embodiments implementing the Ozone control scheme have a relatively higher dependence on grid power.

FIG. 14 shows a cost breakdown of embodiments implementing a solar panel at the PDU level, where the left pie chart shows a cost breakdown summary of an embodiment implementing the embodiment shown in FIGS. 5A and 5B and the right pie chart shows the cost breakdown estimate for a 5KW standard server rack, where some components such as HMI, and PLC, do not need to scale up when server system scales out, such that solar panels, batteries, and inverters are dominant components.

FIG. 15 shows cost trends of deploying an embodiment implementing a solar panel at the PDU level, for matching gradually rising computing demand in scale-out datacenters, such that in a typical 10-year datacenter life, gradually increasing the capacity of installed renewable power system is more economical than conventional centralized integration.

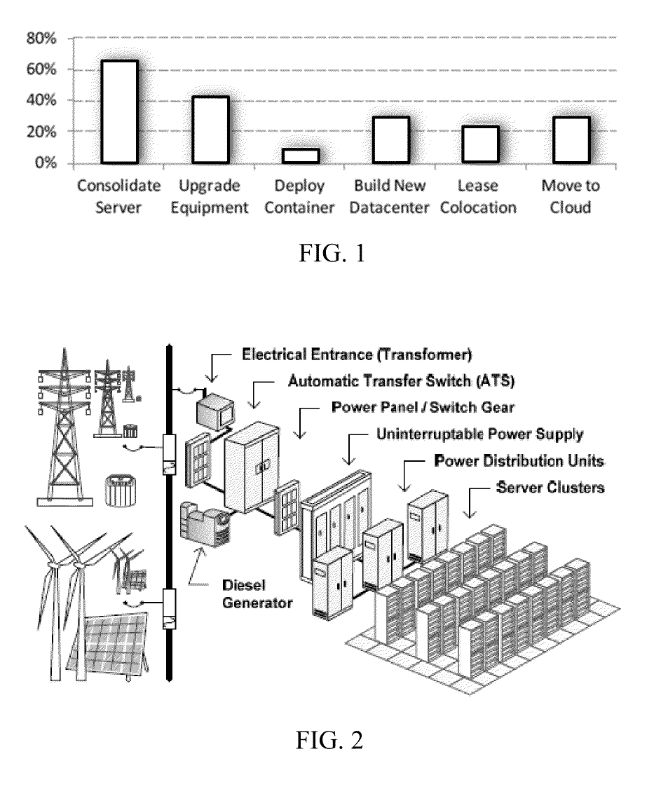

### DETAILED DISCLOSURE

A specific embodiment, which can be referred to as Oasis, relates to a datacenter power provisioning scheme that enables modern power-constrained and/or carbon-constrained datacenters to scale out sustainably and economically. Embodiments incorporating a solar panel at the PDU level can integrate two, and preferably three, of the following: energy source control, power system monitoring, and architectural support for power-aware computing. Embodiments incorporating a solar panel at the PDU level can leverage modular renewable power supplies and distributed energy storage (e.g., battery) architecture to provide automated power provisioning and orchestration. Specific embodiments incorporating a solar panel at the PDU level are able to dynamically distill crucial runtime statistics of different power sources to reduce, or avoid, unbalanced usage of different power sources. Embodiments can identify suitable control strategies and adjust server speed via dynamic frequency scaling to increase, or maximize, the efficiency and/or performance of datacenters. Embodiments incorporating a solar panel at the PDU level can enable a datacenter to increase the datacenter's capacity and/or increase the datacenter's workload capacity using renewable energy sources with less overhead cost. A specific embodiment can double a datacenter's power supply capacity using renewable energy source, with up to 25% less overhead cost.

Embodiments can implement a distributed power provisioning architecture so as to allow existing datacenters to increase the datacenter's power supply capacity incrementally such as by 5%, 10%, 15%, 20%, 25%, or more. By using a “pay-as-you-grow” power provisioning, such that an increment of power supply is added as needed, which can reduce the capital expenditure (CAPEX) and operating expense (OPEX) of modern datacenters. Further specific embodiments use an increment of power supply that is located in a distributed manner.

Embodiments relate to a modular green computing cluster, which can allow a datacenter to increase the datacenter's computing capacity using renewable energy sources. Embodiments can allow a datacenter operator to lower the carbon footprint of the datacenter's computing facilities. Meanwhile, use of a cross-layer power management scheme on the green computing clusters can further increase the productivity and reliability of the datacenter.

1. Embodiments involve a method and apparatus for providing power to a plurality of servers and/or server clusters via power from a utility grid and power provided by a renewable power source at the PDU level, where the power source is preferably a solar panel. Specific embodiments relate to a method and system for providing such power to servers and/or server clusters that are part of a datacenter. Embodiments can also implement a power management scheme to control the generation of such power and/or the demand for such power by the servers and/or server clusters. Embodiments are described in the application that, at times, use the term “a solar panel”, and at other times, use the term “renewable energy source” or the term “renewable power source”, and it is understood the description applies to embodiments using a solar panel and/or other renewable energy source (or renewable power source). Section 2 illustrates an embodiment incorporating a solar panel, or other renewable power source, at the PDU level and the various elements that can interact with the solar panel. Section 3 describes an implementation of an embodiment incorporating a solar panel, or other renewable power source, at the PDU level. Section 4 describes a power management control scheme. Section 5 describes an experimental methodology. Section 6 presents an evaluation of a specific power management control scheme. Section 7 analyzes the cost effectiveness of incorporating a solar panel, or other renewable power source, at the PDU level.

### 2. An Embodiment Incorporating a Solar Panel at the PDU Level

### Overview

In this section an overview of typical datacenter expansion strategies is provided, where these datacenter expansion strategies are referred to as power capacity scale-out models. Modular power sources that can be leveraged to facilitate efficient and flexible capacity expansion are then introduced. Design features of Oasis are then described.

2.1 Scale-Out Models

An existing power capacity scale-out model can be classified as either utility power over-provisioning or centralized power capacity expansion. With utility power over-provisioning, the utility power and datacenter power delivery infrastructure is designed to support the maximum power the load may ever draw, where the datacenter power is produced by one or more energy sources that include a renewable energy source and an output of the one or more energy sources can be at least partially controlled by a datacenter control system. Although such a design provides abundant power headroom for a scale-out server system, such a design inevitably increases the carbon footprint of the scale-out server system. With centralized power capacity expansion, the power delivery infrastructure is provisioned for a certain level of anticipated future power drawn and the scaling out is handled entirely by datacenter-level power capacity integration. However, installing a large-scale renewable power system often results in high expansion cost.

Embodiments incorporating a solar panel at the PDU level allow a “pay-as-you-grow” scale-out for scale-out datacenters to be implemented, which can be referred to as distributed green power increments scale-out. With distributed green power increments scale-out, the utility grid and datacenter power delivery infrastructure are provisioned for a fixed level of load power demand. When the datacenter power demand reaches the maximum capacity based on the fixed level of load power demand, renewable power capacity is added by small increments, and, preferably, in a distributed manner. Adding increments of renewable power capacity in this manner not only provides carbon-reduced, or carbon-free, power capacity expansion to a power-constrained datacenter, but also reduces the amount of capital needed to implement the addition of the increment of renewable power capacity as compared with a large scale addition of a utility power based power source.

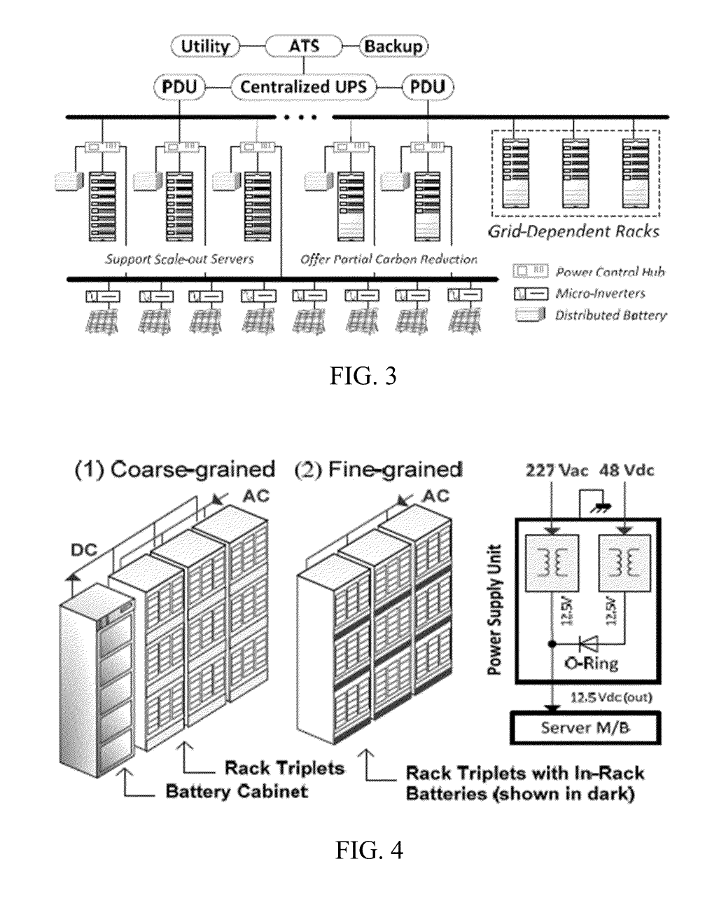

As shown in FIG. 3, embodiments incorporating a solar panel at the PDU level can incorporate a number of green energy powered computing racks, where such computing racks can be referred to as nodes. In the embodiment shown in FIG. 3, each server rack of the node is attached to a distributed power control hub (PCH), which further connects to one or more onsite renewable power supplies, at least one power distribution unit (PDU) for utility power, and local distributed energy storage devices, where a node can be considered an integrated unit that includes a server rack, a renewable power supply, a PCH, and an energy storage device. In Section 2.2 modular power sources are taught. Module power sources can allow the addition of power capacity in an incremental fashion as servers are added, or power demand decreases.

2.2 Modular Power Sources

The scaling out of datacenters typically prompts the addition of both modular standby power sources that provide incremental backup power capacity and modular primary power sources that generate additional electrical power. Today, distributed battery architecture is emerging to improve datacenter efficiency [10, 11]. Embodiments of the subject invention can utilize a distributed battery architecture to add additional backup power as computing demand increases. Embodiments can utilize renewable power supplies, such as solar panels, as modular primary power sources, as solar panels are usually modular and highly scalable in their capacity. Utilizing solar panels as added modular primary power sources is advantageous, and often ideal, as solar panels supply power supplies while keeping carbon emissions down, and solar panels can preferably support carbon-free server scale-out.

2.2.1 Distributed Energy Storage System

Google and Facebook propose employing distributed energy storage to avoid the energy efficiency loss due to power double-conversion in conventional centralized UPS systems [10, 11]. Such de-centralized design can also avoid single-point of failure and increase overall datacenter availability. Recently, the distributed battery topology has been further used to shave peak power to free up datacenter capacity [10]. Embodiments of the subject invention can incorporate a distributed battery architecture when adding energy storage devices during incremental server system scale-out.

FIG. 4 illustrates the distributed battery provisioning architectures in the Open Compute Project [11] led by Facebook, which can be incorporated with embodiments of the subject invention. In the coarse-grained integration scheme, a battery cabinet populated with commodity lead-acid batteries is used to provide standby power for a rack triplet. Each triplet consists of three column racks and each rack is further divided into three power zones. The battery cabinet also includes several breakers, quick fuse disconnects, sensors, and a high current DC bus bar. In the fine-grained integration scheme, the battery cabinet is replaced by a high-density lithium-ion battery backup unit (BBU) in each rack power zone. In both cases, the battery provides 48V DC backup power to the servers and can provide around 45 seconds of runtime at full load [11].

2.2.2 Solar Power with Micro-Inverters

Wind turbine and solar panel are both modular power sources. Compared to wind turbines, solar panels can provide even smaller capacity increments. Embodiments of the invention can incorporate solar panels that use a micro-inverter [12] to provide incremental power capacity.

Conventionally, solar power systems use string inverters, which require several panels to be linked in series to feed one inverter. String inverters can be utilized in accordance with embodiments of the invention. However, as string inverters are big, prone to failure from heat, and show low efficiency, preferred embodiments utilize micro-inverters, which are smaller in size and can be built as an integrated part of the panel itself. As shown in FIG. 3, in one embodiment, each solar panel has its own micro-inverter, and the solar panels are connected in parallel to offer larger power capacity. Compared to a centralized solar panel design, a solar panel with a microinverter can show better scalability, reliability, and efficiency. A disadvantage of a solar panel with a microinverter is the relatively high cost per watt compared to the cost per watt of a solar panel system utilizing a centralized inverter. However, the amortized cost of using solar panels having microinverters can be lower than the amortized cost of a centralized solar panel system (detailed in Section 7).

2.3 Distributed Integration

Embodiments for scaling out a datacenter, such as to add a server or server cluster, additional power source capacity, and additional energy storage capacity, can add renewable power capacity at the power distribution unit (PDU) level. As shown in FIG. 3, PDU-level renewable energy integration allows scaling out a server system on a per-rack basis, or stated another way allows scaling out one or more server racks at a time or one or more server racks at each of multiple locations at a time.

Centralized power integration does not support fine-grained server expansion very well. Current power-constrained datacenters typically over-subscribe pieces of the datacenter's power distribution hierarchy, such as the PDU, thereby creating power delivery bottlenecks. Adding renewable power capacity at a datacenter-level power switch gear does not guarantee increased power budget for the newly added server racks, as the associated PDU may have already reached the PDU's capacity limit.

Although specific embodiments adding solar panels at the PDU level can synchronize the renewable power to the utility power, preferred embodiments provide the current server(s) and/or the added server(s) with either the power provided by the solar panel (optionally supplemented with power provided by the energy storage devices) or utility power provided by, for example, a PDU.

There are three considerations to take into account when determining whether to synchronize the renewable power to the utility power. First, at the PDU level, renewable power synchronization induces voltage transients, frequency distortions, and harmonics. Datacenter servers are susceptible to these types of power anomalies. As the impact of such a power quality issue on server efficiency and reliability is still an open question, adding massive grid-tied renewable power at the server rack level has risks to take into consideration. Second, even if the renewable power is synchronized to the utility power at the datacenter facility-level, a grid-tied renewable power system can still cause efficiency problems, and the newly added renewable power can incur many levels of redundant power conversion before reaching server racks, resulting over 10% energy loss [13]. Third, as required by UL 1741 and IEEE 1547, all grid-tied inverters must disconnect from the grid if power islanding is detected. That is, renewable power systems with grid-tied inverters must shut down if the grid power is no longer present. As reported in a recent survey, the average U.S. datacenter experiences 3.5 power losses per year, with an average duration of over 1.5 hours [14]. Thus, with synchronization based power provisioning, datacenters may lose renewable power supply, due to the UL and IEEE requirements to shut down, even when the renewable power is needed the most.

Embodiments adding a solar panel at the PDU level can facilitate a server scale-out in power-constrained and/or carbon-constrained datacenters. Embodiments adding a solar panel at the PDU level can implement a non-intrusive, modularized renewable power integration scheme, which allows datacenter operators to increase power capacity on-demand (e.g., incrementally) and reduce datacenter carbon footprint gradually. In Section 3 we describe various embodiments adding a solar panel at the PDU level and in Section 4 we describe embodiments of a smart power management scheme, a specific embodiment of which can be referred to as Ozone, which can allow operation of embodiments adding a solar panel at the PDU level in an optimal range, and/or allow Optimized Oasis Operation (O3).

### 3. Embodiments

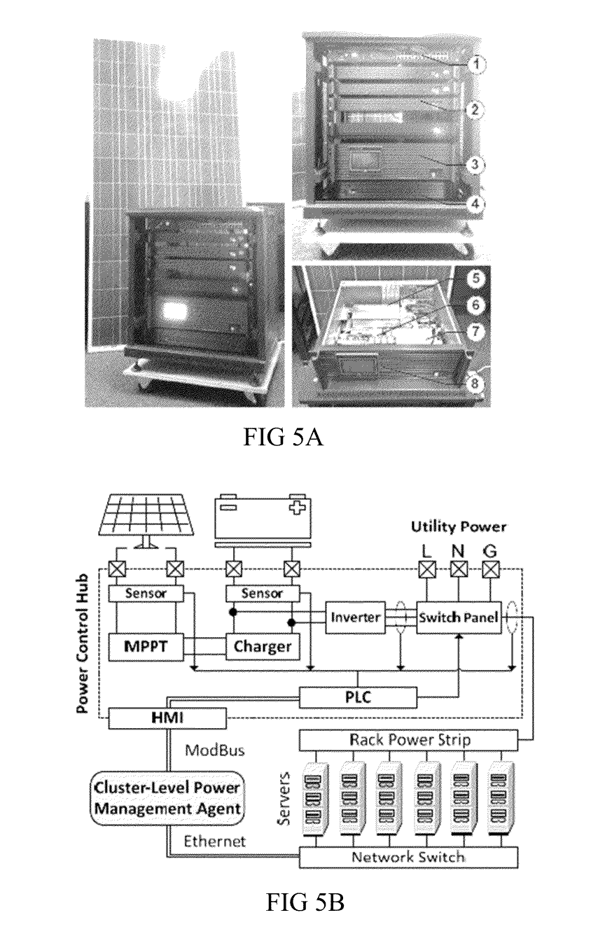

In this section, various embodiments adding a solar panel at the PDU level are described, such as the embodiment shown in FIG. 5A. In a preferred embodiment, the architecture incorporates nodes. As shown in FIG. 5B, the structure of a node is shown, where the node includes a power control hub, a server rack, and a power management agent that coordinates the power control hub and the server rack.

3.1 Power Control Hub

An embodiment of a power control hub (PCH) is shown in FIG. 5B, where the PCH integrates the battery charger, the inverter, the power supply switch panel, the programmable logic controller (PLC), and a human-machine interface (HMI) that allows easy system diagnosis. Specific embodiments can be designed with an HMI. Alternative embodiments do not have an HMI. The PCH is designed to manage multiple energy sources (i.e., renewable power, utility power, and distributed battery devices). On the backside of the PCH three electrical sockets are provided that allow easy connection to utility power (AC), battery (DC), and solar panels (DC). In alternative embodiments, the DC power from the battery and/or the solar panel can be converted to AC before reaching the PCH, such that the PCH receives AC power from the battery and/or the solar panels.

Referring to the embodiment shown in FIG. 5B, there are a variety of variations that can be accomplished in accordance with the subject invention. The PCH can be added to an existing server rack when one or more additional servers are added such that the PCH services existing servers and new server(s), the PCH can be added and a new server rack, or server, can be added such that the PCH services new server(s). The PCH can connect with a single solar panel or multiple solar panels, the PCH can connect with one battery, one energy storage device, multiple batteries, or multiple energy storage devices, the PCH can manage them all. For large datacenters, hundreds of PCH's can be incorporated. In specific embodiments, the PCH can be implemented as a combination of multiple specific control modules, such as a specific solar panel control module for managing the solar panel(s), a specific battery control module for managing the battery or batteries, and a server load adjustment module for managing the server(s).

Embodiments can incorporate an HMI, which can perform one or both of the following: display important power supply data to users to allow for easy diagnosis and configuration, and 2) provides a necessary communication protocol that allows computer servers to directly read the monitored power supply data and control the switching between multiple power supplies.

The system of the embodiment shown in FIG. 5A is powered by an array of solar modules. Each solar module is a 270 Watt Polycrystalline panel from Grape Solar. The solar panel output power is a complex function of the solar irradiation, ambient temperature, and the load connected to it. In the embodiment shown in FIGS. 5A and 5B, to harvest the solar energy, a maximal power point tracker (MPPT) is used in the power control hub. The MPPT samples the output of the solar cells and applies proper control to obtain the optimal solar energy generation. Alternative embodiments can be implemented without the MPPT, or with the MPPT located outside of the PCH. In an embodiment, the MPPT can be a built-in module of the solar micro-inverter.

Embodiments adding a solar panel at the PDU level can utilize distributed energy storage devices, such as distributed battery devices, to provide temporary energy storage, such as temporary energy storage, to store the solar energy provided by the solar panel. The embodiment shown in FIGS. 5A and 5B has the DC power from the solar panels connected to the battery charger, such that the DC solar power can either be fed to the inverter, and then the resulting AC power routed to the server rack, or be fed to the battery to charge the battery. Energy storage devices, such as uninterruptable power supplies (UPS), are widely used in datacenters to address the risk of interruptions of power from the main grid, and can be incorporated with embodiments of the subject invention. In the embodiment shown in FIGS. 5A and 5B, a customized stack of nine 2 Ah sealed lead-acid batteries is connected to the power control hub, where this battery stack is scalable. With respect to the embodiment of FIG. 5A, this battery chassis can provide 5-10 minutes of backup time, depending on the server load.

In an embodiment, the charger identified in FIG. 5B is a converter that converts solar power to appropriate DC power, which can be used to charge the battery. In an embodiment, the MPPT shown in FIG. 5B is a controller that can adjust the output of the charger to maintain the maximum charging efficiency using solar energy. Such a charger and MPPT module are both commercially available. Typically, the MPPT module and charger are bound together to form a MPPT charger. The PCH can leverage such a MPPT charger to improve the solar energy utilization of a node. Specific embodiments do not have an MPPT.

The embodiment of FIG. 5A converts the DC solar power, and/or DC battery power, to AC power, via a DC-AC inverter inside the PCH, so as to match the output level of the utility power. The AC solar power and/or AC battery power and AC utility power are merged (but isolated) at a switch panel in the PCH. A high voltage Omron relay is used to perform the power switching and a Mitsubishi FX2N programmable logic controller (PLC) is used to manage the switch behavior. Finally, the PCH routes power to a rack-level power distribution strip, which further feeds a cluster of server nodes. In the embodiment shown in FIGS. 5A and 5B, the entire server rack is powered by either the utility power or the renewable power, at any particular moment of time, depending on the status of the internal power switch.

Table 1 shows the values of several key technical data of the embodiment of FIG. 5A. The maximum charging current of the system is 4 A, which is limited by the battery charger for battery lifetime considerations. The PCH itself consumes static power (about 9 Watts) due to the HMI and PLC operations. The dynamic power loss is due to the heat dissipation of power conversion systems. The lifetime of the battery system varies depend on its charging/discharging profile. The power management scheme is designed to maximize the benefits of the battery and optimize the battery's service life (detailed in Section 4).

TABLE 1
The measured technical data for
an embodiment implementing Oasis

| | | |
|---|---|---|
| Maximum charging current | 4 | A |
| Static power loss | 9 | W |
| Dynamic power loss | 8.8 | W |
| Battery lifetime (Estimated) | 3~10 | Years |

3.2 System Monitoring and HMI

Embodiments incorporating a solar panel at the PDU level can incorporate one or more sensing components, which can keep monitoring the status of one or more voltages (and/or currents) of the system. The embodiment of FIG. 5A incorporates sensing components that monitor the real-time solar power output voltage and the battery terminal voltage. These hardware agents can provide information regarding the renewable energy resource conditions and the status of the batteries, such as battery lifetime and battery capacity. A systematic checkup of power supply behaviors can also offer a real-time profile of the system's energy utilization. This feature can allow the system to identify, and/or pinpoint, areas of high energy usage in server farms, while establishing a baseline for further capacity planning and optimization. Given appropriate monitoring data, embodiments can enable one or more of the following:

1) Workload application driven energy source switching

2) Energy source driven server load adaptation

3) Emergency handling when facing power anomalies

To facilitate real-time configuration and diagnosis, a human-machine interface (HMI) can be utilized. The embodiment of FIG. 5A uses an HMI for each power control hub. As shown in FIG. 5A, the HMI is a touch screen panel with built in microprocessors that can, for example, display graphics, animation, and/or interchange data to and from the PLC. The HMI device can also serve as a portal for communication between the PLC and the external power management agent.

3.3 Bridging Server and Power Supply

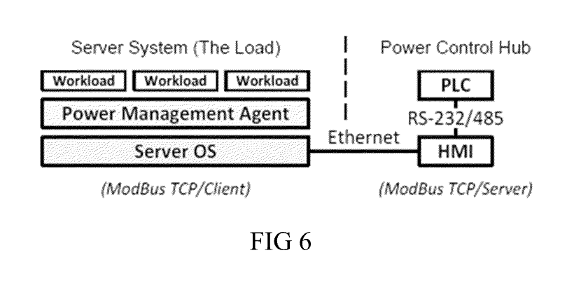

The PCH can set up the communication gateway between the power supply layer and the server workload layer. The design in FIGS. 5A and 5B that sets up the communication gateway between the power supply layer and the server workload layer is partly enlightened by the energy management strategy used in the future smart grid, which focuses on intelligent control, communication, and coordination across electrical loads, power electric interfaces, and power generators. FIG. 6 illustrates the data communication scheme of the embodiment of FIGS. 5A and 5B. The power management agent of FIG. 6 (and FIGS. 5A and 5B) is a middleware that lies between the operating system and the workloads.

The embodiment of FIGS. 5A and 5B uses the Modbus protocol [15] for communication between the power management agent and the power control hub. The Modbus protocol is a widely used serial communication protocol for industrial electronic devices, which is robust and simple. There are several other benefits of using Modbus. First, the Modbus TCP protocol integrates Modbus instruction sets into existing TCP/IP protocol. Therefore, the scalability of Ethernet can be used to easily scale up deployment of nodes (e.g., additional combinations of solar panel(s), batteries, and server(s)) and share information among them. Second, there is no need to worry about the transmission failure of the Modbus instruction as the lower layer TCP/IP protocol has provided the redundant checksum. Typical Modbus TCP communication includes a Modbus server and a Modbus client. In the embodiment of FIGS. 5A and 5B, the power management agent is the Modbus client (master), which initiates the communication requests periodically through the socket to the Modbus server (slave), i.e., the HMI.

3.4 Dynamic Energy Source Switching

The embodiment of FIGS. 5A and 5B is able to dynamically switch between a green (renewable) power supply and the utility power. In specific embodiments the PCH can offer one or more power switching modes. In the embodiment of FIGS. 5A and 5B, the PCH offers two power switching modes, namely the autonomous mode and the coordinated mode.

Autonomous Mode:

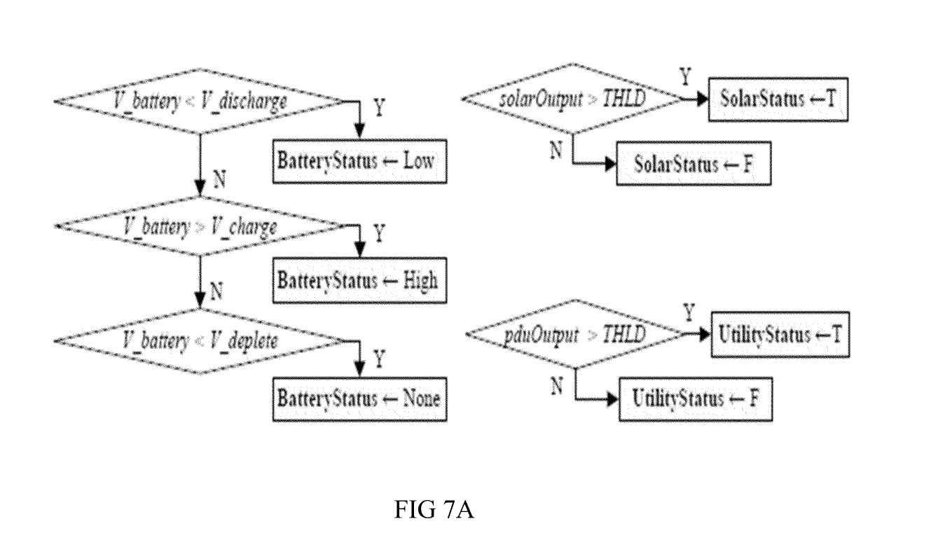

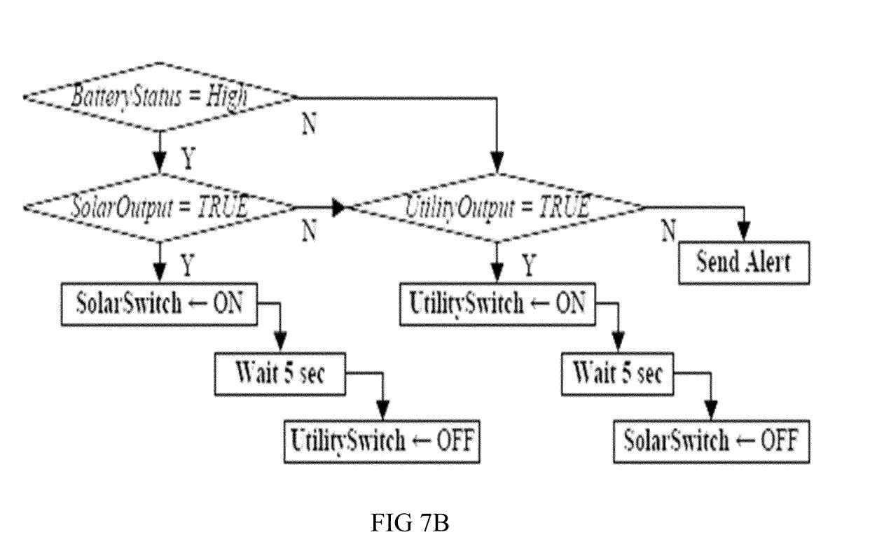

Autonomous mode is the default mode for the embodiment of FIGS. 5A and 5B. In this mode, the embodiment can run autonomously, i.e., switching the load between solar power and utility grid based on the given solar power being generated and the utility power budget. The PLC in the power control hub of the embodiment of FIGS. 5A and 5B defines two atomic modules, which can be referred to as SupplySense and SupplySwitch, as shown in FIGS. 7A-7B. While the module SupplySense focuses on setting parameters that are used for making energy source management decisions, the Supply Switch module executes energy source switching.

Coordinated Mode:

The embodiment of FIGS. 5A and 5B also provides servers the option of establishing power supply switching policies at the server. The embodiment shown in FIG. 5A allows two user-defined operations, which can be referred to as Utility Power Enforcement and Solar Power Enforcement. Users can specify a preferred energy source at runtime, by calling the power management agent. Preferably, the execution of a power supply switching signal depends on battery status, solar power output, and utility power availability, such that a switching request will be ignored if the switching request violates the power budget or causes safety issues.

3.5 Enhancing Power Switching Reliability

In an embodiment, for every switch operation, the controller first checks the output of the power supplies to ensure that the power supplies work normally. As shown in FIGS. 7A-7B, the PCH configuration allows an overlap between solar power and utility power when performing power supply switching, such that one energy source is disconnected only when, for example, the other has been successfully working for at least some period of time, such as at least 1 second, at least 2 seconds, at least 3 seconds, at least 4 seconds, and/or at least 5 seconds. This mechanism helps to avoid potential switching failures, which may interrupt server operation.

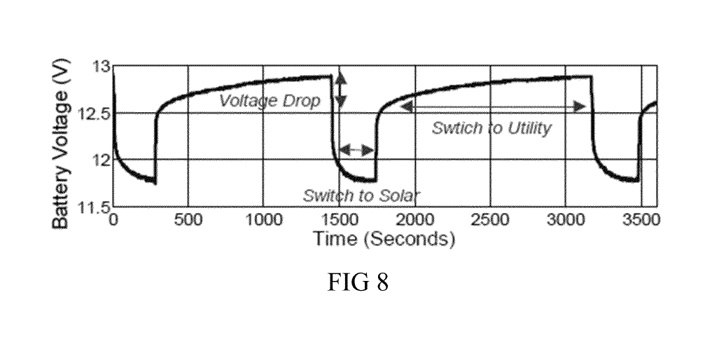

The controller utilized in the embodiment of FIGS. 5A and 5B also maintains appropriate voltage thresholds to prolong the lifetime of backup power system. FIG. 8 shows the measured battery voltage during power switching. The battery starts to discharge at 12.5V (charging threshold) and stops discharging when the battery voltage drops to 11.8V (or other discharging threshold). The charging/discharging thresholds prevent batteries from entering deep-discharging or over-charging mode. In addition, the large inrush currents due to power switching can result in an immediate voltage droop (about 0.4V) in the battery pack described above having the stack of nine 2 Ah sealed lead-acid batteries, as shown in FIG. 8. Embodiments can incorporate battery management circuitry to mitigate such abnormal battery drain issues.

3.6 Server Power Demand Control

Controlling the server power demand can be quite important (especially the peak power drawn) when renewable energy generation fluctuates. As an example, when solar power output decreases, the average processing speed of the server cluster can be temporarily lowered, to avoid shutting down any one of the serves of the service cluster. Although batteries can be used to provide backup power capacity, it is typically preferable not to heavily rely on the batteries to provide backing power capacity, due to reliability considerations.

Dynamic voltage and frequency scaling (DVFS) can be utilized for server load adaptation with embodiments of the invention, and is utilized for server load adaption in the embodiment shown in FIGS. 5A and 5B. It has been shown that DVFS can reduce the peak power drawn of a server cluster by 18% for real-world datacenter workload mix [16]. The system kernel of the system of FIGS. 5A and 5B is configured with the on-demand frequency scaling governor. Embodiments can set the server system at different CPU operating states (C states) and performance states (P states). Based on the supply monitoring data and workload power demand statistics, embodiments can perform real-time supply-driven load adaptation.

### 4. Operation of Embodiments in an Optimal Operating Range and/or Optimized Oasis Operation

The flexibility of the power provisioning architecture of various embodiments adding a solar panel at the PDU level can provide a datacenter owner plenty of room for improving the efficiency and performance of the servers of the datacenter. In this section, an embodiment is described, which can be referred to as Ozone, that provides a power management scheme for operating embodiments adding a solar panel at the PDU level in an optimal range, and in a specific embodiment, for operating an embodiment adding a solar panel at the PDU level in an optimized manner, which can be referred to as Optimized Oasis Operation (O3). Embodiments implementing the Ozone control scheme can enable embodiments adding a solar panel at the PDU level to efficiently scale-out datacenters.

Embodiments, such as an embodiment implementing the Ozone control scheme, can seek a balance between power supply management and server load management. In addition to the basic power control rules of embodiments adding a solar panel at the PDU level, embodiments implementing the Ozone control scheme feature a set of policies, such as criteria to base conditional actions on, with the intent to take advantage of multiple energy sources without heavily relying on any single energy source. In addition, embodiments implementing the Ozone control scheme can adaptively adjust the server load based on power supply states to take advantage of the designs tradeoffs.

While many factors may affect the operation of embodiments adding a solar panel at the PDU level, embodiments implementing the Ozone control scheme can take into account one or more of six representative factors for making control decisions. Three of these six factors are power-related, namely Utility Budget, Solar Budget, and Load Demand; two of these six factors are battery-related, namely Discharge Budget and Remaining Capacity; and one of these six factors is a Switch parameter that specifies which energy source is in use as the primary power.

Further embodiments implement power control schemes that differ from the Ozone control scheme, while adjusting the server load and/or the power supply output power usage based on one or more parameters of the system.

4.1 Managing Battery Usage

Batteries have a lifespan (typically 5-10 years) estimated by their manufactures. These energy storage devices become no longer suitable for mission-critical datacenters after the battery's designed service life expires. Typically, aggressively discharging batteries significantly degrades the battery lifetimes. Further, even when batteries are not frequently used, (e.g., discharged) such batteries still suffer aging and self-discharging related problems.

An embodiment can use an Ah-Throughput Model [17] for battery lifespan optimization. This model assumes that there is a fixed amount of aggregated energy (overall throughput) that can be cycled through a battery before the battery requires replacement. The model provides a reasonable estimation of the battery lifetime and has been used in software developed by the National Renewable Energy Lab [18].

During runtime, the subject system can dynamically monitor battery discharging events and calculate battery throughput (in amp-hour) based on Peukets's equation [19]:

Discharge=I_{actual}·(I_{actual}/Iₙₒₘᵢₙₐₗ)^{pc-1}·T Equation (1)

In Equation (1), I_{actual} is the observed discharging current, Iₙₒₘᵢₙₐₗ is the nominal discharging current, which is given by the manufacturer, pc is the Peukets coefficient, and T is the discharging duration. Over time, the aggregated battery throughput is given by:

D_{agg}=ΣᵢDischargeᵢ Equation (2)

To avoid battery over-utilization, a soft limit on battery usage at any given time can be set. At the beginning of each control cycle, the Oasis nodes can receive a Discharge Budget, D_{B}, which specifies the maximum amount of stored energy use that will not compromise battery lifetime. Assuming the overall battery throughput is Dₜₒₜₐₗ, the Discharge Budget is set as:

D_{B}=Dₜₒₜₐₗ−D_{agg} Equation(3)

The Discharge Budget affects both power supply switching behavior and server workload adaptation control. When the Discharge Budget is inadequate, embodiments can be configured to prefer to switch the server back to utility power or decrease server power demand to avoid heavily utilizing the battery system.

4.2 Managing Backup Capacity

Distributed battery systems not only provide basic support for managing time-varying renewable power, but can also serve as uninterruptible power supplies for scale-out servers.

Maintaining necessary backup capacity is important, and in many situations critical. It has been shown that exceeding the UPS capacity is one of the most common root causes of unplanned outages in datacenters [14]. The backup capacity is the primary factor in determining UPS autonomy (a.k.a. backup time). Backup capacity is a measure of the time for which the UPS system will support the critical load during a power failure. In addition to the Discharge Budget, embodiments can also set a limit on the minimum remaining capacity of batteries. The embodiment of FIGS. 5A and 5B only uses 40% of the installed battery capacity for managing renewable power shortfall (referred to as Flexible Capacity). In this embodiment, the remaining 60% battery capacity (i.e., Reserved Capacity) is only used for emergency handling purpose. When the battery capacity drops below 60%, the server is switched from the renewable power supply to the utility power supply.

4.3 Managing Server Performance

Due to the time-varying nature of renewable energy resources, embodiments can be designed to handle a variable renewable power budget. Embodiments can provide one or more power management options. Specific embodiments can provide one or both of the following options: (1) decrease the server performance level to lower server power demand to a server power demand that does not result in a power shortfall, and (2) continue to operate the servers at the highest frequency, or another desired frequency, and use the energy storage devices to compensate for the power shortfall. Specific embodiments can provide an option that decreases the server performance level and also uses the energy storage devices to provide some power. To find the best design tradeoff between server performance and system reliability, embodiments can cooperatively control the power supply switching and the server processing speed. The power control decision tree for an embodiment of the invention is shown in Table 2. In this embodiment, adaptive selection of one of two power management options based on the observed Discharge Budget and the amount of Flexible Capacity is provided, where the first option is to decrease the server performance level to a server power demand that does not result in a power shortfall and the second option is to continue to operate the servers at the highest frequency and use the energy storage devices to compensate for the power shortfall.

In the embodiment the results of which are shown in Table 2, when both Discharge Budget and Flexible Capacity are adequate, the highest priority is given to server performance boost (i.e., run workload at the highest frequency) with the support of the battery. Further, when the system runs out of Discharge Budget, but still has Flexible Capacity, the server is allowed to keep using power from the renewable power source (green energy) with a reduced server frequency. If the stored energy drops below 60% of its installed capacity, the load is switched to the utility power side.

TABLE 2
The power control decision tree for an embodiment
P_{Load} > P_{Renewable}

| | | | | |
|---|---|---|---|---|
| 1 | R | DB > 0 | upsC > 60% | Switch = ‘N’, cpuFreq = ‘Highest’ |
| 2 | | | upsC < 60% | Switch = ‘Y’, cpuFreq = ‘TBD’ |
| 3 | | DB = 0 | upsC > 60% | Switch = ‘N’, cpuFreq = ‘Low’ |
| 4 | | | upsC < 60% | Switch = ‘Y’, cpuFreq = ‘TBD’ |
| 5 | U | DB > 0 | upsC > 80% | Switch = ‘Y’, cpuFreq = ‘Highest’ |
| 6 | | | upsC < 80% | Switch = ‘N’, cpuFreq = ‘TBD’ |
| 7 | | DB = 0 | upsC > 80% | Switch = ‘Y’, cpuFreq = ‘Lowest’ |
| 8 | | | upsC < 80% | Switch = ‘N’, cpuFreq = ‘TBD’ |

P_{Renewable} > P_{Load}

| | | | | |
|---|---|---|---|---|
| 9 | R | — | — | Switch = ‘N’, cpuFreq = ‘Highest’ |
| 10 | U | — | — | Switch = ‘Y’, cpuFreq = ‘Highest’ |

R—Renewable power side;
U—Utility power side;
DB—Discharge budget;
upsC—Estimated battery/ups capacity;
Y—Switch the power supply;
N—Don’t switch;
TBD—Server speed scales evenly depending on actual power budget;

### 5. Evaluation Methodology

An evaluation framework was implemented using the embodiment of the subject system shown in FIGS. 5A and 5B. The evaluation framework is configured into three layers, namely the Power Budget Control Layer, the Oasis Operation Layer, and the Data Collection and Analytic Layer.

In the Power Budget Control Layer, the system is fed with a pre-defined power budget. The peak server power demand is used as a default utility power budget for the system. To ensure a fair comparison, real-world solar power traces are collected and used as a renewable power budget for experiments run with this embodiment.

In the Operation Layer, four 1U rack-mounted servers are set up as the computing load, as shown in Table 3. These server nodes are high-performance lower-power computing nodes that use Intel Core i7-2720QM 4-core CPU as a processing engine. The measured idle power and peak power of each server are 21 W and 55 W, respectively. With the Intel Turbo Boost Technology, these processors support up to a 3.3 GHz operating frequency.

Xen 4.1.2 with Linux kernel 2.6.32.40 is deployed on each server node. Both para-virtualization and hardware virtualization are used to support different virtual machines with various memory size. Multiple virtual machines are booted to execute different workloads on each server. The relocation feature of VM in Xen is enabled and the virtual machine is live migrated by using command (xm migrate DOMID IP-1). The Xen power management feature is also enabled to dynamically tune the vCPU frequency by using command (xenpm set-scaling-speed cupid num and xenpm set-scalinggovornor cupid gov). The system kernel is configured with the on-demand frequency scaling governor. The minimum frequency is set as 0.8 GHz and the normal frequency is set as 2.2 GHz.

Various datacenter workloads are chosen from Hibench [20] and CloudSuite [21]. Hibench consists of a set of representative Hadoop programs, including both synthetic micro-benchmarks and real-world applications. CloudSuite is a benchmark suite designed for emerging scale-out applications that are gaining popularity in today's datacenters. As shown in Table 4, ten workloads are selected from five roughly classified categories. Within each experiment, a workload is executed iteratively.

In the Data Collection and Analytic Layer, a front-end network server is deployed to communicate with the server cluster through a TP-Link 10/100M rack-mounted switch. The network server uses an AMD low power 8-core CPU with 16 GB installed memory. System drivers are written using Linux socket to enable data communication between the front-end server and the server node. The collected battery charging/discharging statistics and the measured server power consumption data are stored in a log file. A Watts UP Pro power meter [22] is also used for measurements in energy-related experiments. This power meter is able to display instantaneous power consumption with relatively high accuracy (1.5%). This power meter also provides internal memory for storing up to 120K of history power data.

The battery lifetime is evaluated based on the observed battery usage profile. The battery is assumed to have a cycle life of 5000 times and a maximal service life of ten years. Note that this design is orthogonal to the actual battery specifications. This design can optimize the service life of a variety of battery scenarios, thereby increasing the overall cost-effectiveness of a datacenter.

TABLE 3
Computing platform setup
Computing Nodes

| | |
|---|---|
| CPU | Intel Core i7-2720QM, 4-core, 2.2 G, TDP 45 W |
| Memory | 8 GB, registered |
| Disk | Seagate Barracuda 7200 RPM, 500 GB |
| M/B | SuperMicro ITX Socket G2 Motherboard |

Front-End Server

| | |
|---|---|
| CPU | AMD Opteron 4256 EE, 8-Core 2.5 G, TDP 32 W |
| Memory | 16 GB, registered |
| Disk | Seagate Barracuda 7200 RPM, 1000 GB |
| M/B | SuperMicro ATX Socket C32 Motherboard |
| Switch | TP-Link TL-SF1024 24-Port Unmanaged 10/100M |

TABLE 4
Evaluated workloads [20, 21]

| Abbr. | Workload | Category |
|---|---|---|
| Sort | Sort program on Hadoop | Micro Benchmarks |
| WC | Word count program on Hadoop | Micro Benchmarks |
| Rank | Page rank algorithm of Mahout | Web Search |
| Nutch | Apache Nutch indexing | Web Search |
| Bayes | Bayesian classification | Machine Learning |
| KM | K-means clustering | Machine Learning |
| Web | Web serving | Internet Service |
| Media | Cline-server media streaming | Internet Service |
| YCSB | Yahoo! cloud serving benchmark | Cloud Application |
| Test | Software testing | Cloud Application |

### 6. Results

In this section the impact of various power supply switching and server adaptation schemes are evaluated. Specifically, three kinds of power management schemes are evaluated, namely, Oasis-B, Oasis-L, and Ozone. The operation features of each of these three power management schemes are summarized in Table 5. In the following sub-sections, the performance of these three control schemes is first investigated. The impacts of these three control schemes on battery lifetime and emergency handling capabilities are then discussed. The energy usage profile of these three control schemes is then evaluated. Finally, the cost issue is discussed for embodiments adding a solar panel at the PDU level.

TABLE 5
The evaluated power management schemes

| Schemes | Description |
|---|---|
| Oasis-B | Battery-oriented design. Focuses on using energy storage |
| | management. May result in low load performance if the |
| | stored energy is not enough. |
| Oasis-L | Load-oriented design. Focuses on the load power scaling |
| | capability of servers. It uses frequency scaling first, then |
| | leverage battery to compensate the power shortfall. |
| Ozone | Optimized control. Focuses on balanced usage of server |
| | load adaptation and the stored renewable energy. |

6.1 Performance

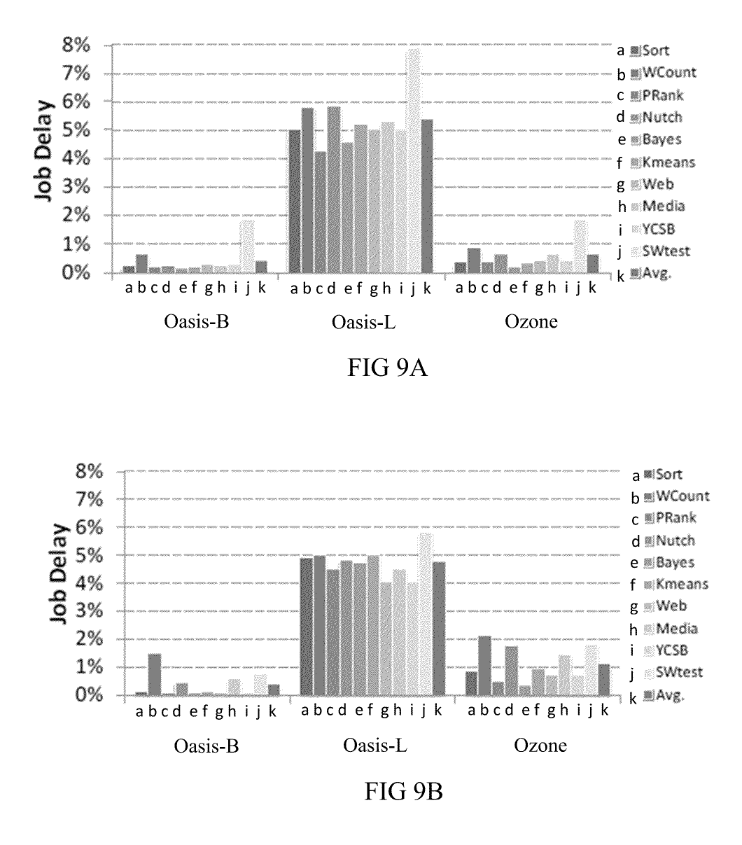

Job turn-around time is an important, and often critical metric, for emerging data-analytic workloads in scale-out datacenters. FIGS. 9A-9B show the increase in job turn-around time (resulting from the execution latency due to server performance scaling) under both high-variability and low-variability solar power generation scenarios. In FIG. 9A, the mean turn-around time, when implementing the Oasis-B, Oasis-L and Ozone control schemes, is increased by 0.5%, 5.4%, 0.6%, respectively. In FIG. 9B, the turn-around time, when implementing the Oasis-B, Oasis-L and Ozone control schemes, is increased by 0.4%, 4.7%, 1%, respectively.

As can be seen, Oasis-B shows the best performance. This is because Oasis-B trades off battery lifetime for server performance. In contrast, Oasis-L shows a much higher server performance degradation, as the processing frequency is frequently lowered to match the inadequate renewable power budget. In FIGS. 9A and 9B, the results of Ozone are very close to Oasis-B. On average, Ozone yields less than 1% server performance degradation compared to Oasis-B, which heavily uses the battery to provide power shortfall.

6.2 Battery Lifetime

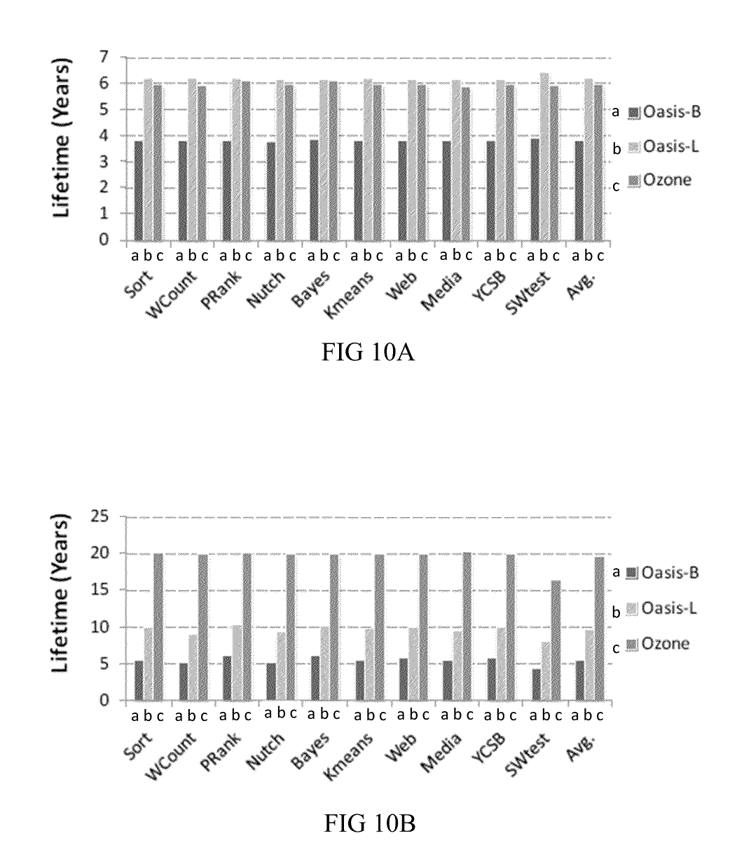

In FIGS. 10A-10B, the battery service life is estimated based on detailed battery profiling information. A longer battery service life is favored, as it lowers the total cost of ownership (TCO).

When the power supplied by the renewable power supply varies significantly, the operation of server nodes typically requires substantial support from the energy storage device. As a result, the predicted battery lifetime is much shorter than the designed battery service life (10 years), as shown in FIG. 10A. On average, the battery lifetime, when implementing the Oasis-B, Oasis-L, and Ozone control schemes, is 3.9 years, 6.2 years, and 6.0 years, respectively. Due to the over-use of the battery systems, the battery service life of Oasis-B is only 63% of Oasis-L. In contrast, the average battery lifetime of Ozone is 97% of Oasis-L. Compared to implementing the Oasis-B control scheme, implementing the Ozone control scheme can increase the battery lifetime by more than 50%.

When the power supplied by the renewable power supply does not vary significantly, as shown in FIG. 10B, the battery service lifetime of all the three power management schemes increases significantly, as the batteries are not frequently discharging. However, commercial batteries will not typically last for 20 years, even if the batteries are not frequently discharging, such that when the power supplied by the renewable energy source does not vary significantly embodiments implementing the Ozone control scheme may result in the battery system being under-utilized. Many other issues, such as aging and leakage, will become the dominant factors for battery lifetime estimation, when the batteries are used for an extended duration with infrequent discharging. In the real world, batteries are used much more frequently, as renewable power systems do not typically maintain peak output throughout the service lives of the batteries.

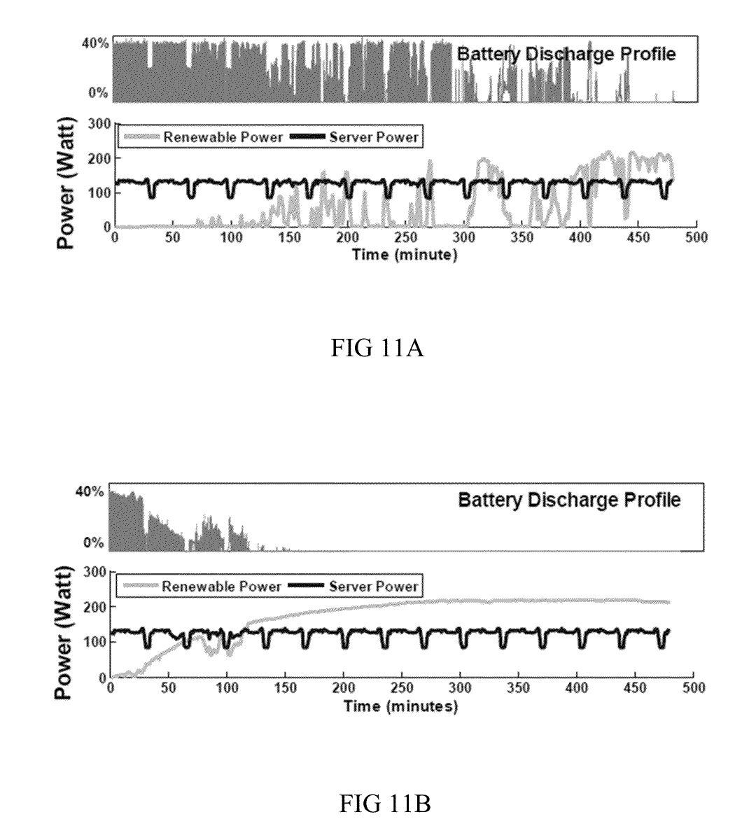

FIGS. 11A-11B illustrate the problem of uneven battery usage. Note that when the power supplied by the renewable power supply does not vary significantly (i.e., the renewable power output is constantly high), the distributed battery system is rarely used. In contrast, when the renewable power output fluctuates severely, batteries start to show the impact of heavy charging and discharging activities. Therefore, Discharging Budget can be saved in scenarios like FIG. 11B, and the Discharging Budget saved in scenarios like FIG. 11B can be used in scenarios like FIG. 11A to provide load power support. In fact, embodiments providing renewable power sources on-site can opportunistically leverage stored energy to boost system performance, without significantly affecting the battery service life. Such leveraging may be possible even when current Discharging Budget is zero. In circumstances where the renewable power generation (renewable power supply output) is likely to not vary significantly for some time period in the near future, the controller can advance the server system a certain amount of stored energy, when there is still Flexible Capacity in the battery.

6.3 Emergency Handling Capability

When datacenter servers are scaled out, the server node backup up power should be increased accordingly. While instantaneous workload performance boost is important for a server node, maintaining the necessary backup capacity is even more important. A low battery backup capacity can pose significant risk, since the backup generator may not be ready to pick up the load.

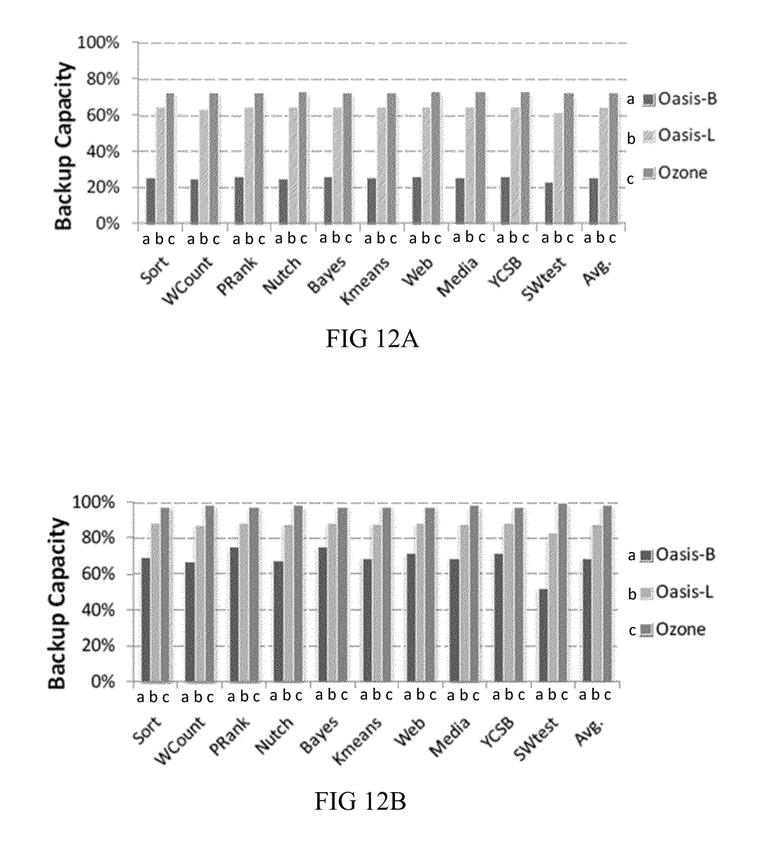

In FIGS. 12A-12B, the average UPS capacity during runtime is shown, for different power management mechanisms. Embodiments using the Ozone control scheme can maintain around a 73% backup capacity when the renewable power output variability is high (FIG. 12A) and about a 98% backup capacity when the renewable power output variability is low (FIG. 12B). Embodiments using the Oasis control scheme suffer increased numbers of charging/discharging cycles in circumstances where the renewable power output varies significantly. Therefore, the backup capacity is low for all three of the power management schemes for which data is provided in FIG. 12A. Without setting a limit on the battery usage and the minimum battery stored capacity when the renewable power output variability is high, the battery backup time can drop by up to 75%, or more (i.e., Oasis-B).

6.4 Energy Usage Profile

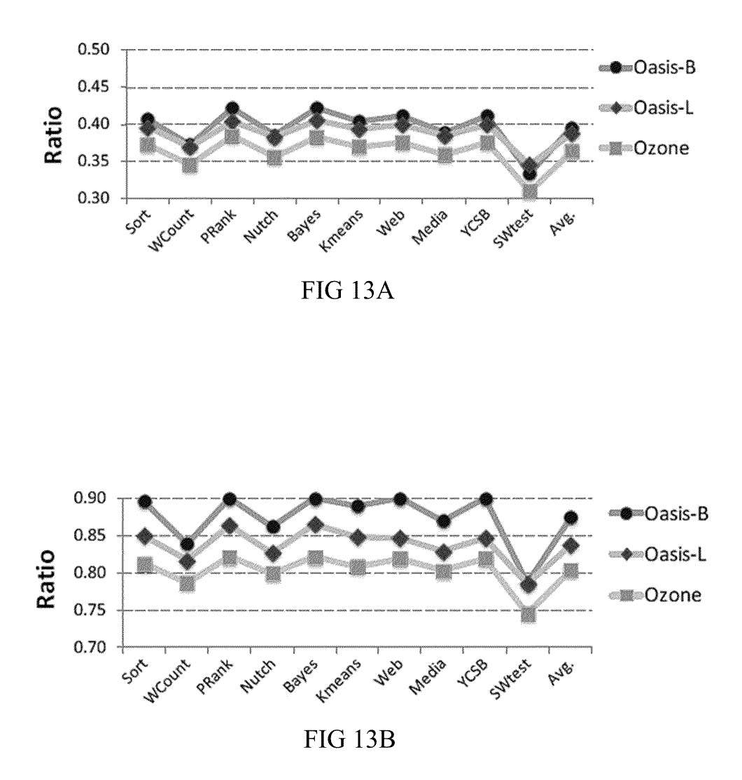

For datacenters with a heavy data-processing computing task, it is often desirable to have a significant amount of runtime, which typically consumes a large amount of energy. Leveraging green energy (e.g., renewable power sources) to provide additional power can save considerably on utility power bills and lower the negative environmental impact of carbon-constrained datacenters. In FIGS. 13A-13B, datacenter green energy utilization, as the ratio of renewable energy usage to overall IT energy consumption, is evaluated.

While embodiments implementing the Ozone control scheme yield impressive system performances, battery lifetimes, and battery backup capacities, such embodiments show relatively lower green energy utilization. Compared to embodiments implementing the Oasis-B control scheme, embodiments implementing the Ozone control scheme yield 8% less renewable power rate when the renewable power output varies significantly (FIG. 13A) and 11% less renewable power rate when the renewable power output does not vary significantly (e.g., renewable power generation is high) (FIG. 13B). The reason Oasis-B shows high green energy usage is that it heavily uses the battery to harvest renewable energy. In contrast, Oasis-L aggressively scales the load power demand to match the renewable power generation.

### 7. Cost Analysis

Cost-effectiveness has become one of the top factors that drive server-class system design and optimization. In this section, the impact of utilizing renewable energy sources at the PDU level on the cost of large datacenters is discussed. The system cost is estimated based on a collected operation log of a server node in the embodiment shown in FIGS. 5A and 5B, trusted industry datasheets, manufacturer specifications, and government publications.

7.1 Cost Breakdown of a Server Node

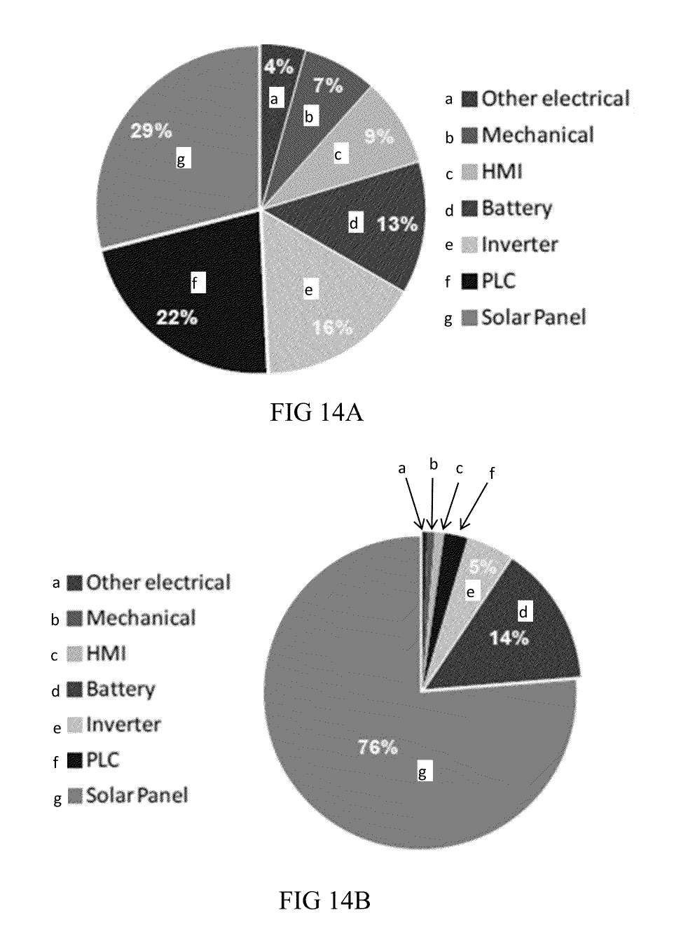

The cost of the design incorporating a renewable energy source in accordance with the embodiment shown in FIGS. 5A and 5B (excluding the IT server cost and the cost of labor) is first evaluated. FIG. 14 presents two pie charts that show cost breakdowns, where the pie chart on the left shows the cost breakdown for the embodiment shown in FIGS. 5A and 5B, and the pie chart on the right shows the cost breakdown of a system similar to the embodiment shown in FIGS. 5A and 5B and having a 40U standard server with moderate density (<10 KW). As can be seen, the solar panel is the most expensive component (accounts for about 29% of the overall expenditure) for the renewable energy powered server system shown in FIGS. 5A and 5B, followed by the PLC module (22%), the power inverter (16%), the battery (13%), and the HMI (9%).

On the right pie chart, the cost breakdown of a design utilziing a renewable power source, which includes a 40U standard server with moderate density (<10 KW), where the rack is assumed to be populated with 20 SuperMicro 1017R Xeon 1U servers. The cost of a power control hub as shown in FIG. 5B, including a 5 KW inverter, is about $1.2K. It is approximately 4% of the total cost of the server equipment. While PLC and HMI are both major cost components in the embodiment shown in FIGS. 5A and 5B, the PLC and HMI actually account for only a very small portion of the total cost of ownership for a large-scale datacenter. In addition, the PLC and HMI do not need to scale up when more server systems are added. In contrast, power provisioning systems, such as solar panels, batteries, and inverters, need to increase their capacities to meet the growing load demand. Since embodiments using a PCB as shown in FIG. 5B are designed to take advantage of existing battery systems in a datacenter, solar panels and power inverters are often the major hardware additions when scaling up to account for the addition of more servers.

7.2 Cost Projection for Large Deployment

Centralized renewable power integration has relatively low initial cost due to the scale effect. Recent report estimates that a small-scale PV panel (around 5 KW, for residential use) has an installed price of $5.9/W, while large-scale PV panel (several hundred KW) has a lower price of around $4.74/W [23]. In addition, the solar power inverter accounts for about 10%-20% of the initial system cost [24]. Central inverters in the several MWs level are often cheaper compared to micro inverters (typically <10 KW) used in the controller shown in FIG. 5B. The former costs around $0.18/W, while the later costs around $0.5/W [25].

The main advantage of utilizing renewable power sources in accordance with embodiments of the subject invention is that users can gradually increase the installed renewable power capacity, thereby reducing, and potentially, eliminating the inefficiency of over-provisioning. The ever-decreasing component cost can then be taken advantage of to further lower total expenditures. It has been shown that the installed prices of U.S. residential and commercial PV systems declined 5%-7% per year, on average, from 1998-2011, and by 11%-14% from 2010-2011, depending on system size [25]. The cost of a micro-inverter has also been decreasing by 5% yearly [25].

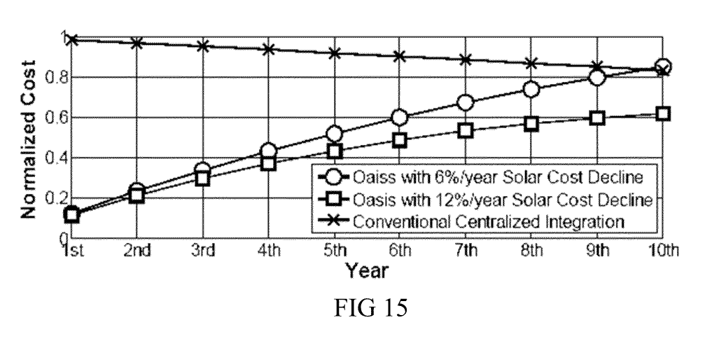

FIG. 15 illustrates how utilizing renewable power sources in accordance with embodiments of the subject invention helps to improve the overall cost-effectiveness of renewable energy powered scale-out datacenters. In FIG. 15, it is assumed that users evenly increase the deployment of renewable energy sources, with a ten-year scale-out plan (e.g., equip 10% of the datacenter servers with solar power system every year). For the cost of solar power system, data based on a conservative decline rate of 6% per year is shown, and data based on an optimistic decline rate of 12% per year is shown. Electricity cost savings of renewable energy powered systems are calculated based on real historical solar power traces. Hourly solar irradiance measurement data (January 2003-December 2012, 24 hours a day), provided by the NREL Solar Radiation Research Laboratory [26] is used. The utility power is assumed to be $0.1/kWh and datacenters are assumed to be able to sell excess renewable power to the utility.

FIG. 15 shows the cost overhead (total additional cost due to renewable power integration) for different design scenarios. The results are normalized to the one-time expenditure of datacenter-level renewable power integration. For a conventional green datacenter that uses centralized renewable power integration, a 17% investment return (due to the electricity cost savings) is expected after ten years. However, this estimation is optimistic as the utility grid typically uses negotiated renewable power feed-in tariff that has a lower purchase price. In addition, for safety reasons, there is also a limit on the maximum amount of renewable power that can be synchronized with the utility power. The overall cost of implementing renewable power sources at the PDU level in accordance with embodiments of the invention is close to the conventional centralized design, if solar power costs decrease by a conservative rate of 6% per year. If solar power costs decline faster, namely, 12% per year, adding renewable power sources at the PDU level in accordance with embodiments of the invention can result in a 25% lower overhead cost, compared to a centralized design.

Aspects of the invention, such as monitoring system parameters, controlling the operation of system elements, and communicating with various system element via a communication link, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, transitory and non-transitory, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile disks (DVD), holographic media or other optical disk storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCES

[1] C. Belady, Projecting Annual New Datacenter Construction Market Size, Global Foundation Services, Technical Report, 2011
[2] J. Koomey, Growth in Data Center Electricity Use 2005 to 2010, Analytics Press, 2011
[3] The 2012 Uptime Institute Data Center Industry Survey, The Uptime Institute, 2012
[4] D. Bouley, Estimating a Data Center's Electrical Carbon Footprint, Schneider Electric White Paper Library, 2011
[5] http://www.microsoft.com/environment/
[6] http://www.ibm.com/ibm/environment/climate/
[7] http://www.google.com/green/energy/
[8] http://www.apple.com/environment/renewable-energy/
[9] http://green.ebay.com/greenteam/ebay/
[10] V. Kontorinis, L. Zhang, B. Aksanli, J. Sampson, H. Homayoun, E. Pettis, T. Rosing, and D. Tullsen, Managing Distributed UPS Energy for Effective Power Capping in Data Centers, International Symposium on Computer Architecture (ISCA), 2012
[11] P. Sarti, Battery Cabinet Hardware v1.0, Open Compute Project, 2012
[12] H. Sher, and K. Addoweesh, Micro-inverters—Promising Solutions in Solar Photovoltaics, Energy for Sustainable Development, Elsevier, 2012
[13] B. Fortenbery, and W. Tschudi, DC Power for Improved Data Center Efficiency, Lawrence Berkeley National Laboratory, Technical Report, 2008
[14] National Survey on Data Center Outages, Ponemon Institute, White Paper, 2010
[15] Modbus Protocol, http://www.modbus.org/
[16] X. Fan, W. Weber, and L. Barroso, Power Provisioning for a Warehouse-Sized Computer, International Symposium on Computer Architecture (ISCA), 2007
[17] H. Bindner, T. Cronin, P. Lundsager, J. Manwell, U. Abdulwahid, I. Gould, Lifetime Modelling of Lead Acid Batteries, Risø National Laboratory, Technical Report, 2005
[18] HOMER Energy Modeling Software, http://homerenergy.com/
[19] D. Doerffel, and S. Sharkh, A Critical Review of Using the Peukert Equation for Determining the Remaining Capacity of Lead-Acid and Lithium-ion Batteries. Journal of Power Sources, 2006
[20] S. Huang, J. Huang, J. Dai, T. Xie, and B. Huang, The HiBench Benchmark Suite: Characterization of the MapReduce-Based Data Analysis. Data Engineering Workshops, IEEE International Conference on Data Engineering, 2010
[21] CloudSuite 2.0, http://parsa.epfl.ch/cloudsuite
[22] Watts Up? Meters, https://www.wattsupmeters.com
[23] D. Feldman, G. Barbose, R. Margolis, R. Wiser, N. Darghouth, and A Goodrich, Photovoltaic (PV) Pricing Trends: Historical, Recent, and Near-Term Projections, Joint Technical Report, National Renewable Energy Laboratory and Lawrence Berkeley National Laboratory, 2012
[24] A Review of PV Inverter Technology Cost and Performance Projections, Navigant Consulting Inc. and National Renewable Energy Lab, Technical Report, 2012
[25] R. Simpson, Levelized Cost of Energy from Residential to Large Scale PV, The Applied Power Electronics Conference and Exposition, 2012
[26] SRRL Baseline Measurement System, http://www.nrel.gov/midc/srrl_bms/
[27] P. Lotfi-Kamran, B. Grot, M. Ferdman, S. Volos, O. Kocberber, J. Picorel, A. Adileh, D. Jevdjic, S. Idgunji, E. Ozer, and B. Falsafi, Scale-Out Processors, International Symposium on Computer Architecture (ISCA), 2012
[28] S. Li, K. Lim, P. Faraboschi, J. Chang, P. Ranganathan, and N. Jouppi, System-Level Integrated Server Architectures for Scale-out Datacenters, International Symposium on Microarchitecture (MICRO), 2011.
[29] D. Wang, C. Ren, and A. Sivasubramaniam. Virtualizing Power Distribution in Datacenters, International Symposium on Computer Architecture (ISCA), 2013
[30] C. Li, W. Zhang, C. Cho, and T. Li, SolarCore: Solar Energy Driven Multi-core Architecture Power Management, International Symposium on High-Performance Computer Architecture (HPCA), 2011
[31] N. Sharma, S. Barker, D. Irwin, and P. Shenoy, Blink: Managing Server Clusters on Intermittent Power, International Conference on Architectural Support for Programming Languages and Operating Systems (ASPLOS), 2011
[32] I. Goiri, K. Le, T. Nguyen, J. Guitart, J. Torres, and R. Bianchini, GreenHadoop: Leveraging Green Energy in Data-Processing Frameworks, European Conference on Computer Systems (EuroSys), 2012
[33] Y. Zhang, Y. Wang, and X. Wang, GreenWare: Greening Cloud-Scale Data Centers to Maximize the Use of Renewable Energy, International Middleware Conference (Middleware), 2011
[34] N. Deng, C. Stewart, D. Gmach, M. Arlin, and J. Kelley, Adaptive Green Hosting, International Conference on Autonomic Computing (ICAC), 2012
[35] Z. Liu, M. Lin, A. Wierman, S. Low, and L. Andrew, Greening Geographical Load Balancing, International Joint Conference on Modeling and Measurement of Computer Systems (SIGMETRICS), 2011
[36] I. Goiri, W. Katsak, K. Le, T. Nguyen, and R. Bianchini, Parasol and GreenSwitch: Managing Datacenters Powered by Renewable Energy, International Conference on Architectural Support for Programming Languages and Operating Systems (ASPLOS), 2013
[37] C. Li, R. Zhou, and T. Li, Enabling Distributed Generation Powered Sustainable High-Performance Data Center, International Symposium on High-Performance Computer Architecture (HPCA), 2013
[38] C. Li, A. Qouneh, and T. Li, iSwitch: Coordinating and Optimizing Renewabel Energy Powered Server Clusters, International Symposium on Computer Architecture (ISCA), 2012
[39] C. Li, A. Qouneh, and T. Li, Characterizing and Analyzing Renewable Energy Driven Data Centers, International Joint Conference on Modeling and Measurement of Computer Systems (SIGMETRICS), 2011
[40] C. Li, R. Wang, N. Goswami, X. Li, T. Li, and D. Qian, Chameleon: Adapting Throughput Server to Time-Varying Green Power Budget Using Online Learning, International Symposium on Low Power Electronics and Design (ISLPED), 2013
[41] M. Hague, K. Le, I. Goiri, R. Bianchini, and T. Nguyen, Providing Green SLAs in High Performance Computing Clouds. International Green Computing Conference (IGCC), 2013
[42] N. Deng, C. Stewart, and J. Li, Concentrating Renewable Energy in Grid-Tied Datacenters, International Symposium on Sustainable Systems and Technology (ISSST), 2011
[43] S. Govindan, D. Wang, A. Sivasubramaniam, and B. Urgaonkar, Leveraging Stored Energy for Handling Power Emergencies in Aggressively Provisioned Datacenters, Battery Emergency, International Conference on Architectural Support for Programming Languages and Operating Systems (ASPLOS), 2012
[44] S. Govindan, A. Sivasubramaniam, and B. Urgaonkar, Benefits and Limitations of Tapping into Stored Energy for Datacenters, International Symposium on Computer Architecture (ISCA), 2011
[45] C. Ren, D. Wang, B. Urgaonkar, and A. Sivasubramaniam, Carbon-aware Energy Capacity Planning for Datacenters, International Symposium on Modeling, Analysis and Simulation of Computer and Telecommunication Systems (MASCOTS), 2012
[46] M. Arlitt et al., Towards the Design and Operation of Net-Zero Energy Data Centers, IEEE Intersociety Conference on Thermal and Thermomechanical Phenomena in Electronic Systems (ITherm), 2012

1. A datacenter, comprising:
a plurality of power control hubs (PCH's), wherein each PCH of the plurality of PCH's is configured to connect to one or more power distribution unit (PDU) such that the each PCH receives PDU AC power from the one or more PDU;
a corresponding plurality of server clusters, wherein each server cluster comprises at least one server, wherein each server cluster of the plurality of server clusters is connected to a corresponding PCH of the plurality of PCH's;
a corresponding plurality of energy storage devices (ESD's), wherein each ESD of the plurality of ESD's is connected to a corresponding PCH of the plurality of PCH's; and
a corresponding plurality of renewable power supplies (RPS's), wherein each RPS of the plurality of RPS's is connected to a corresponding PCH of the plurality of PCH's,
wherein each PCH of the plurality of PCH's comprises:
a switch;
a converter/inverter, wherein the converter/inverter is configured to:
(i) receive ESD DC output power from the corresponding ESD, convert the ESD DC output power to ESD AC output power, and provide the ESD AC output power to the switch; and/or
(ii) receive RPS DC output power from the corresponding RPS, convert the RPS DC output power to RPS AC output power, and provide the RPS AC output power to the switch,
wherein the switch is configured to switchably either:
(a) provide the PDU AC power to the corresponding server cluster when the switch is in a first switch position; or
(b) provide the RPS AC output power and/or the ESD AC output power to the corresponding server cluster when the switch is in a second position; and
a controller, wherein the controller is configured such that,
when the switch is in the first switch position, the controller switches the switch from the first switch position to the second switch position if a first at least one criterion is met, and
when the switch is in the second switch position, the controller switches the switch from the second position to the first position if a second at least one criterion is met.

2. The datacenter according to claim 1, further comprising:
the one or more power distribution units (PDU's), wherein each PDU of the one or more PDU's is configured to connect to a centralized uninterruptable power supply (UPS) so as to receive utility AC power from the centralized UPS.

3. The datacenter according to claim 1,
wherein each EDS of the plurality of EDS's comprises one or more batteries,
wherein each RPS of the plurality of RPS's comprises one or more solar panels.

4. A datacenter, comprising:
at least one server cluster, wherein each server cluster of the at least one server cluster comprises at least one server, wherein the at least one server cluster is configured to connect to one or more power distribution unit (PDU) such that the at least one server cluster receives PDU AC power from the one or more PDU;
a corresponding at least one energy storage device (ESD), wherein power from each ESD of the at least one ESD is provided to the corresponding server cluster of the at least one server cluster;
a power control hub (PCH), wherein the PCH is configured to connect to one or more additional PDU such that the PCH receives PDU AC power from the one or more additional PDU,
a renewable power source (RPS), wherein the RPS is connected to the PCH;
an additional server cluster, wherein the additional server cluster comprises at least one additional server;
an additional ESD, wherein the additional ESD is connected to the PCH;
wherein the PCH comprises:
a switch;
a converter/inverter, wherein the converter/inverter is configured to:
(i) receive ESD DC output power from the additional ESD, convert the ESD DC output power to ESD AC output power, and provide the ESD AC output power to the switch; and/or
(ii) receive RPS DC output power from the RPS, convert the RPS DC output power to RPS AC output power, and provide the RPS AC output power to the switch,
wherein the switch is configured to switchably either:
(a) provide the PDU AC power to the corresponding server cluster when the switch is in a first switch position; or
(b) provide the RPS AC output power and/or the ESD AC output power to the corresponding server cluster when the switch is in a second position; and
a controller, wherein the controller is configured such that,
when the switch is in the first switch position, the controller switches the switch from the first switch position to the second switch position if a first at least one criterion is met, and
when the switch is in the second switch position, the controller switches the switch from the second position to the first position if a second at least one criterion is met.

5. The datacenter according to claim 4, further comprising:
the one or more power distribution units (PDU's), wherein each PDU of the one or more PDU's is configured to connect to a centralized uninterruptable power supply (UPS) so as to receive utility AC power from the centralized UPS; and
the one or more additional PDU, wherein each additional PDU of the one or more additional PDU's is configured to connect to a centralized uninterruptable power supply (UPS) so as to receive utility AC power from the centralized UPS.

6. The datacenter according to claim 4,
wherein the additional ESD comprises one or more batteries,
wherein the RPS comprises one or more solar panels.

7. A method of providing power to a datacenter, comprising:
providing at least one server cluster, wherein each server cluster of the at least one server cluster comprises at least one server, wherein the at least one server cluster is configured to connect to one or more power distribution unit (PDU) such that the at least one server cluster receives PDU AC power from the one or more PDU;
providing a corresponding at least one energy storage device (ESD), wherein power from each ESD of the at least one ESD is provided to the corresponding server cluster of the at least one server cluster;
providing a power control hub (PCH), wherein the PCH is configured to connect to one or more additional PDU such that the PCH receives PDU AC power from the one or more additional PDU;
providing a renewable power source (RPS), wherein the RPS is connected to the PCH;
providing an additional server cluster, wherein the additional server cluster comprises at least one additional server;
providing an additional ESD, wherein the additional ESD is connected to the PCH;
wherein the PCH comprises:
a switch;
a converter/inverter, wherein the converter/inverter is configured to:
(i) receive ESD DC output power from the additional ESD, convert the ESD DC output power to ESD AC output power, and provide the ESD AC output power to the switch; and/or
(ii) receive RPS DC output power from the RPS, convert the RPS DC output power to RPS AC output power, and provide the RPS AC output power to the switch,
wherein the switch is configured to switchably either:
(a) provide the PDU AC power to the corresponding server cluster when the switch is in a first switch position; or
(b) provide the RPS AC output power and/or the ESD AC output power to the corresponding server cluster when the switch is in a second position; and
a controller, wherein the controller is configured such that,
when the switch is in the first switch position, the controller switches the switch from the first switch position to the second switch position if a first at least one criterion is met, and
when the switch is in the second switch position, the controller switches the switch from the second position to the first position if a second at least one criterion is met.

8. The method according to claim 7, further comprising:
providing the one or more power distribution units (PDU's), wherein each PDU of the one or more PDU's is configured to connect to a centralized uninterruptable power supply (UPS) so as to receive utility AC power from the centralized UPS; and
providing the one or more additional PDU, wherein each additional PDU of the one or more additional PDU's is configured to connect to a centralized uninterruptable power supply (UPS) so as to receive utility AC power from the centralized UPS.

9. The method according to claim 7,
wherein the additional ESD comprises one or more batteries,
wherein the RPS comprises one or more solar panels.
